(19) United States
(12) Patent Application Publication
(10) Pub. No.: US 2012/0118094 A1
(43) Pub. Date: May 17, 2012

(54) DEVICE FOR CONTROLLING A MECHANICAL GEARBOX OF A VEHICLE BY CABLES USING A LEVER

(75) Inventors: Philippe Pradier, Sorbiers (FR); Xavier Lecrinier, Saint Etienne (FR); Francois Matraglia, Frans (FR)

(73) Assignee: DURA AUTOMOTIVE SYSTEMS SAS, Bievres (FR)

(21) Appl. No.: 13/322,711

(22) PCT Filed: May 21, 2010
(86) PCT No.: PCT/FR10/50993

§ 371 Date: Feb. 1, 2012

(30) Foreign Application Priority Data
May 28, 2009 (FR) 0953516

(51) Int. Cl. F16H 59/02

(52) U.S. Cl. 74/473.15

(57) ABSTRACT

A device has, in a vicinity of the lever and gearbox, members capable of being rotated as a result of displacement of the lever in order to exert a pull on strands of flexible cables attached to the members, regardless of the direction of angular displacement of the lever corresponding to gear shifting or gear selection. In the vicinity of the lever, one of the members is directly secured to the lever to constitute a shifting member, while the other member is controlled by the lever via a return element and constitutes a selection member.

The invention relates to the technical field of equipment for motor vehicles and more particularly relates to a cable-operated linkage for controlling a gearbox, particularly a mechanical gearbox, by means of a lever.

As is well known, a gearbox control lever is fitted with a capacity for angular displacement in a holder attached to a portion of the motor vehicle, for example on the floor.

The support has features allowing installation with the capacity for multidirectional movement of the lever, especially in the form of a ball-and-socket joint such as a ball joint.

Control of the actual gearbox by using the lever is obtained by rigid rods or cables. For example, the base of the lever is coupled in an articulated manner to a rigid cable fitted in a sheath. The other end of this rigid control cable is attached to the gearbox mechanism in order to shift said gears.

Gear selection is also obtained by means of a bar or a rigid cable. For example, the ball joint has, in a manner that is substantially perpendicular to the lever, a finger coupling for mounting a return and gear selection element. The lower end of the return element, opposite to that coupled to the ball joint, is designed to attach, with the capacity for articulation, the rigid cable in question which is also fitted in a sheath. For example, the end of this cable is secured to a hinged end with the return element.

It is clear from these arrangements that the bars or rigid control cables are subjected to tensile and thrust forces, depending on the direction of travel of the lever, both for gear shifting and gear selection. The cables must therefore be sufficiently rigid to withstand the thrust forces, depending on the direction of travel of the lever, without deformation; this also makes it necessary to fit them in a sheath. This results in significant costs.

On the other hand, this necessary rigidity makes it impossible to obtain large bend radii and so cable runs have to be substantially straight.

The invention has set itself the object of overcoming these drawbacks in a simple, dependable, effective and efficient manner.

The problem that the invention proposes to solve is to reduce costs significantly with the objective of dispensing with the need to have, between the lever and the gearbox, rigid control and coupling cables.

To solve such a problem, a device for controlling a mechanical gearbox by cables by using a lever which has, at the level of the lever and the gearbox, features capable of allowing a pulling action on the strands of flexible cables, regardless of the direction of angular displacement of the lever corresponding to gear shifting or gear selection, has been designed and developed.

Given these characteristics, it is possible to use a flexible bicycle-type cable having a diameter, for example, of 1.5 to 2 mm.

To solve the problem of subjecting the strands of the cable to tensile forces only, the features consist, for gear shifting and selection, of members capable of being rotated as a result of movement of the lever, with the cable strands being connected to said members.

Advantageously, the members are at least partially circular.

According to another aspect, at the level of the lever, one of the members is directly secured to said lever to form the shifting member, while the other member is controlled by the lever through a return element and constitutes the gear selection member.

In one embodiment, at the level of the lever, the gear shifting and selection members are arranged in two vertical planes that are substantially parallel. At the level of the gearbox, in one embodiment indicated merely by way of example, the shifting member is arranged in a substantially horizontal plane, while the selection member (selector) is arranged in a substantially vertical plane.

Building on this basic design, either the coupling strands between the shifting members on the lever side and gearbox side and the coupling strands between the selection members on the lever side and gearbox side form, respectively, part of a single cable or the coupling strands between the shifting members on the lever side and the gearbox side and the coupling strands between the selection members on the lever side and gearbox side are, respectively, independent.

In one embodiment, the cable is fixed in features which an area of the rotating shifting member has and which an area of the rotating selection member has on the lever side and the gearbox side.

In this embodiment, to solve the problem of ensuring coupling of the cable with the rotating shifting and selection members, on the lever side, the features for fixing the rotating members consist of a tension shoe in which a locking pin is mounted, this assembly being subjected to a return spring and said locking pin being shaped to leave the cable free at the time of assembly and then ensure locking of the shoe after the cable has been tensioned and secured.

Such arrangements make it possible to compensate for the chain of dimensions resulting from any misalignment between the neutral position of the lever and the gearbox and manufacturing tolerance intervals and positional tolerance intervals.

Advantageously, the cable is engaged in a peripheral groove which the rotating members have and the locking pin, which ensures locking of the cable and prevents translational movement of the shoe, cooperates with a protruding area of the periphery of the rotating shifting and selection member in question on the lever side.

If the strands of the cable are independent, the cable is secured in features that two distinct areas of the rotating shifting member have and which two distinct areas of the rotating selection member have on the lever side and gearbox side.

Another problem that the invention proposes to solve is to obtain, based on this control device which uses flexible cables, a perfectly linear grid, as opposed to existing solutions where shifting takes place along a very slightly curved trajectory.

To resolve this problem, on the lever side, the rotating members define, relative to the axis of symmetry of said lever, an angular sector of about 20° on the even-gear shifting side and an angular sector of about 40° on the odd-gear shifting side, said angular sectors being on the same gearbox side. The lever arm between, on the one hand, the axis of rotation of the selection and shifting members on the lever side and gearbox side and, on the other hand, the point of tangency of the cable strands in relation to said members is always the same, so the ratio is constant. In addition, the connection between the lever and selection return is in an oblong hole, so that rotation of the selection return does not affect the trajectory of the lever.

The invention is explained below in greater detail, reference being made to the accompanying drawings in which:

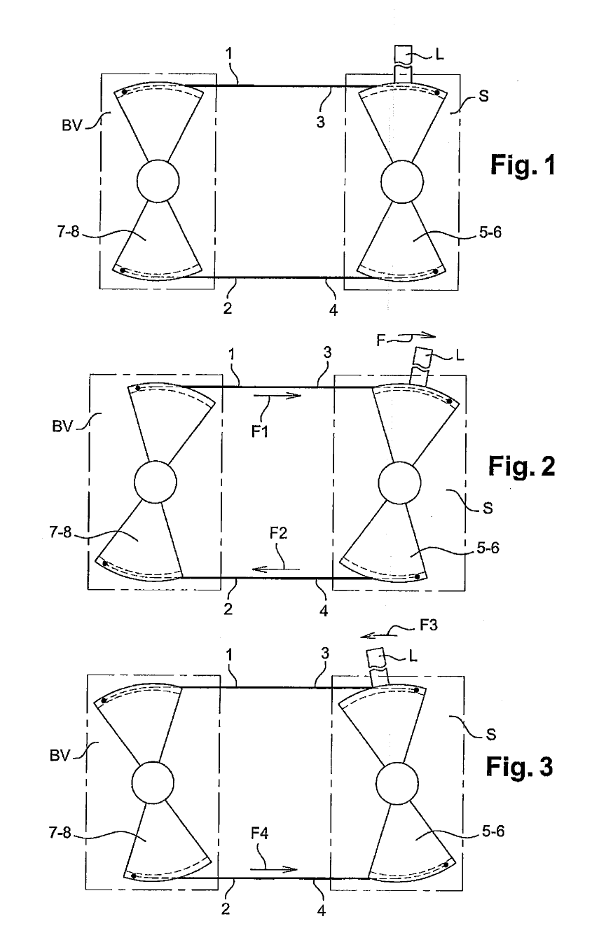

FIGS. 1 to 3 are purely schematic views showing the operating principle of the control device according to the invention, from a neutral position of the lever corresponding, for example, to the dead centre (FIG. 1); when the lever is pushed (FIG. 2) or pulled (FIG. 3);

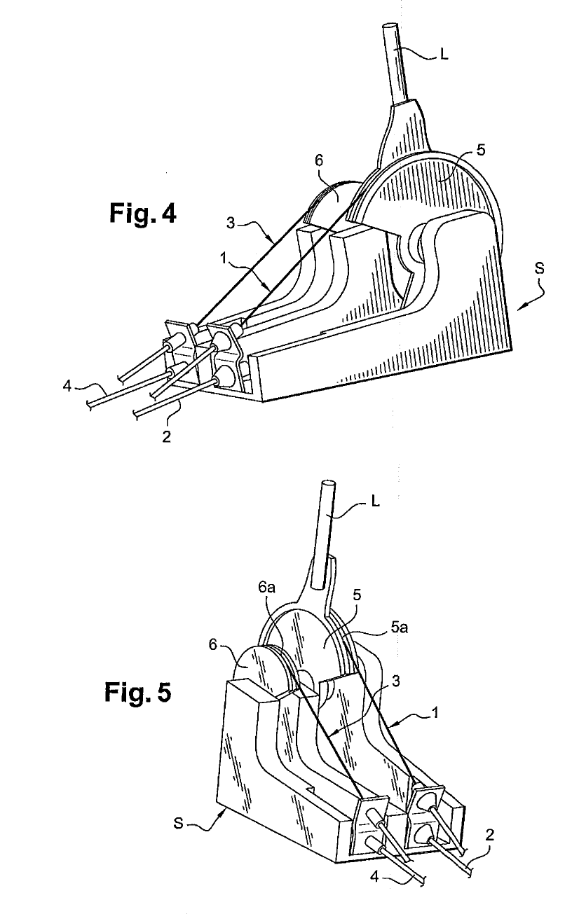

FIGS. 4 and 5 are perspective views of the control device seen from the lever side;

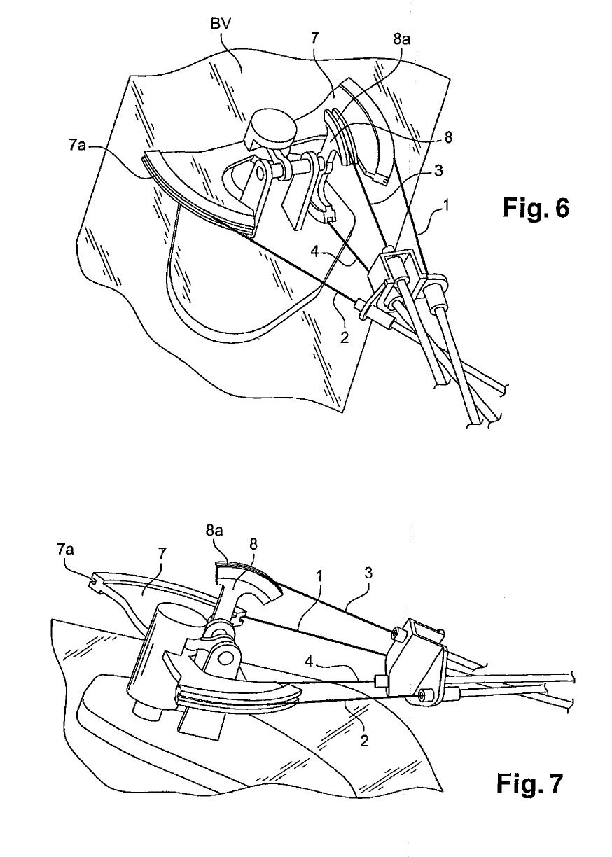

FIGS. 6 and 7 are views of the device seen from the gearbox side;

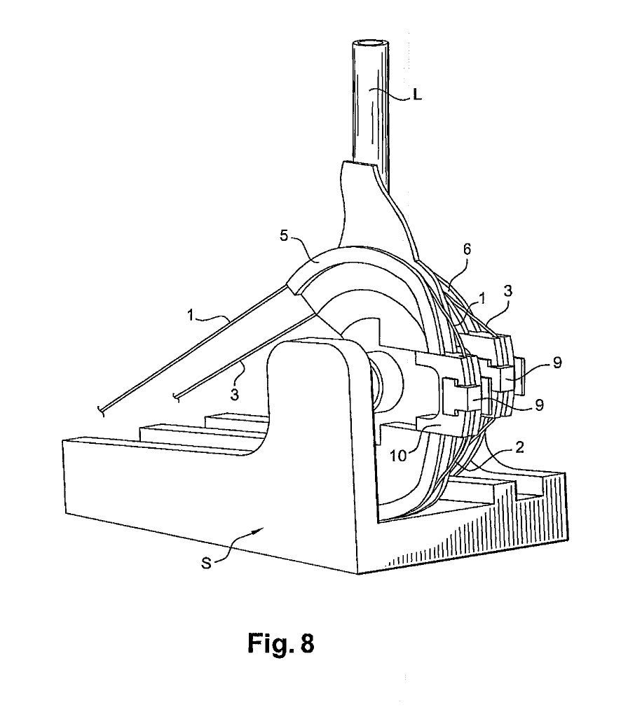

FIG. 8 is a perspective view of the control lever seen from the lever side showing a solution to attach and fix a single cable at the level of an area which has rotating gear shifting and selection members;

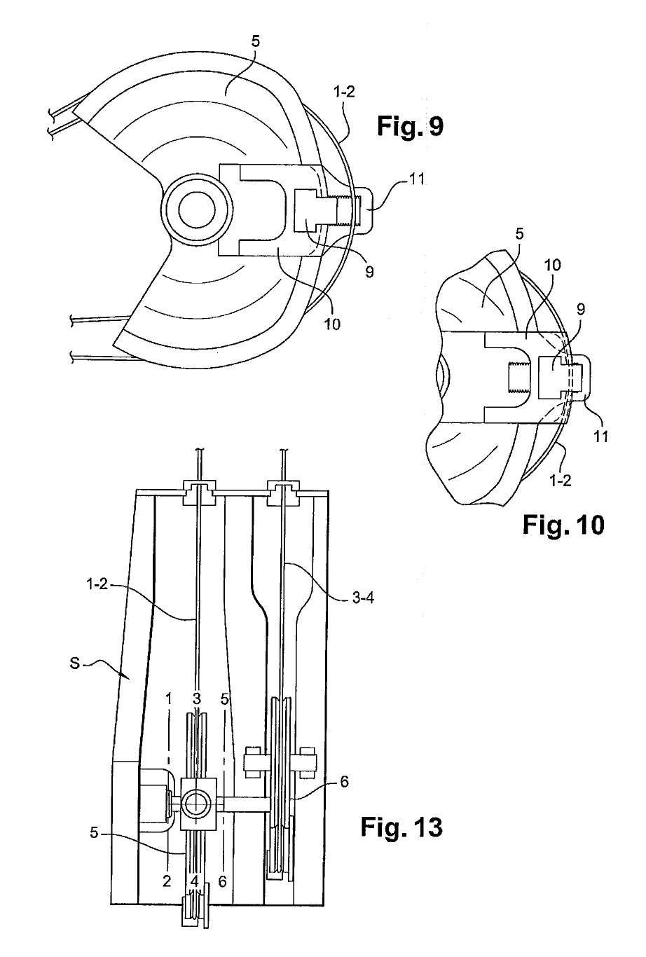

FIGS. 9 and 10 are partial views showing the corresponding free position (FIG. 9) and the position in which the body is locked relative to the corresponding rotating member;

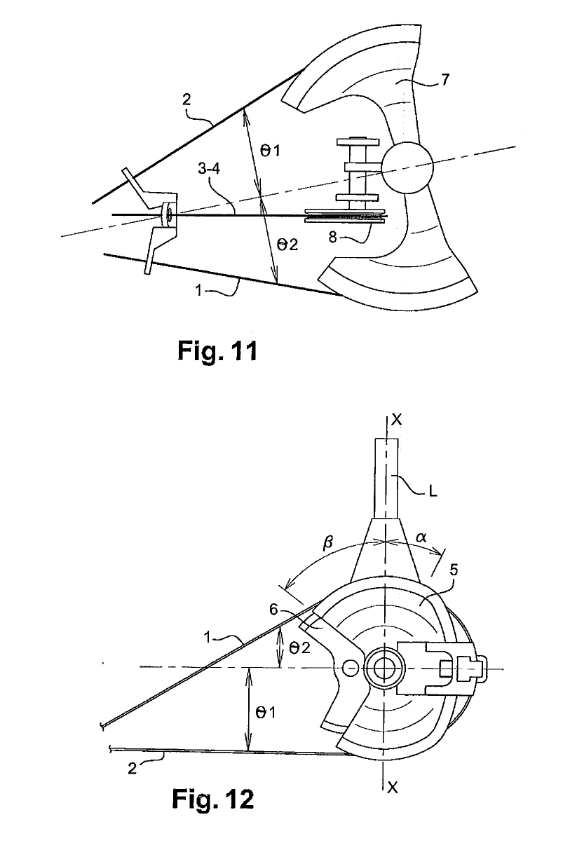

FIGS. 11 and 12 are schematic views showing the constancy of the ratio as a function of movement of the lever on the gearbox side and the lever side;

FIG. 13 is a top view of the support where the lever is mounted in accordance with the characteristics of the invention which make it possible to obtain a perfectly linear grid.

The invention relates to a control device for a mechanical gearbox (BV) using lever (L) mounted with the capacity for multidirectional articulation in a housing support (S).

According to one basic aspect of the invention, the gears are controlled, using lever (L), both in terms of gear shifting and gear selection, through flexible cable strands (1), (2) and (3), (4). To achieve this and as shown by the diagrams in FIGS. 1, 2 and 3, the device has, at the level of lever (L) and gearbox (BV), features (5), (6), (7) and (8) capable of allowing a pulling action on cable strands (1), (2) and (3), (4), regardless of the direction of travel of the lever, both linearly for gear shifting, i.e. by pushing or pulling the lever, and angularly in a way that corresponds to gear selection.

These arrangements are made for gear shifting, at the level of control lever (L) and the gearbox as such, by members (5) and (7) and, for gear selection, by members (6) and (8). These various members (5), (7) and (6), (8) are able to be rotated as a result of displacement of lever (L), in combination with the strands of cable (1), (2) and (3), (4).

The reader is referred to the embodiment shown in FIGS. 4, 5, 6 and 7.

At the level of housing support (S), control lever (L) is directly subject, at its base, to member (5) which has a generally partially circular shape. Lever (L), equipped with member (5), is mounted in housing support (S) in a manner that is familiar to those skilled in the art with the aim of it being able to move linearly, in one direction or another, for gear shifting and angularly, in one direction or another, for selecting said gears.

This rotating member (5) is arranged in a substantially vertical plane and is connected by the strands of cable (1) and (2) to member (7) which is mounted at the level of the gearbox (BV) for gear shifting. Rotating member (7) is arranged in a substantially horizontal plane. Cable strands (1) and (2) are engaged in a groove (5a) and (7a) formed at the periphery of members (5) and (7) by being fixed there by any known and appropriate means.

Similarly, member (6) is mounted on housing support (S) with the capacity to be rotationally driven due to the effect of angular tilting of lever (L) in one direction or another. For example, member (6) which has a generally partially circular shape, is subject to lever (L) via a return element shown in FIG. 13 and made, for example, in the form of a selection finger attached to the lever and housed in an oblong hole of the selection return as is well known to those skilled in the art in the case of a conventional control bar or rigid cables.

Member (6) is connected by cable strands (3) and (4) to member (8) which also has a generally partially circular shape and is arranged at the level of gearbox (BV) for selecting said gears. Member (6) can be arranged in a vertical plane, in a way that is substantially parallel to member (5). Similarly, in one embodiment, the selector (8) is arranged in a vertical plane that is substantially perpendicular to the horizontal plane that bounds member (7). In the same way as for gear shifting, cable strands (3) and (4) are engaged in grooves (6a) and (8a) formed at the periphery of members (6) and (8) by being fixed there by any known and appropriate means.

In one embodiment, coupling strands (1) and (2) for shifting members (5) and (7) and coupling strands (3) and (4) for selection members (6) and (8) are part of the same cable. In this case, shifting cable (1)-(2) is fixed in features which an area of rotating shifting member (5) on the lever side has and an area which the periphery of rotating member (7) on the gearbox side has. Similarly, cable selection (3)-(4) is fixed in features which an area of the periphery of member (6) has and an area of the periphery of rotating member (8). In this embodiment, one therefore uses two cables (1)-(2) and (3)-(4) which form loops at the level of members (5)-(7) and (6)-(8).

An advantageous embodiment of this attachment area on the periphery of rotating members (5) and (6) is shown in FIGS. 8, 9 and 10. The mounting features of this area consist of a pad (10) that is subject to a spring. A locking pin (9) is mounted on the pad and locks the position of the pad once the spring has been released and creates a physical link between the cable and the lever. Locking pin (9) interacts with a projecting zone (11) formed on the periphery of the rotating shifting member (5) and selection member (6) in question.

The entire locking pin (9) and its mounting features, particularly at the level of the protruding area (11), are shaped to leave shifting cable (1)-(2) and selection cable (3)-(4) free at the time of assembly. The spring tightens the cable and then the locking pin ensures locking of said cable.

In another embodiment, gear shifting coupling strands (1) and (2) and coupling strands (3) and (4) on the gear selection side are independent. In other words, in this case, gear shifting is obtained by means of two flexible cables, while gear selection is also obtained using two flexible cables, making a total of 4 cables for shifting and selection—(1), (2), (3), (4).

The operating principle of the device is illustrated in FIGS. 1, 2 and 3. FIG. 1 represents any position of lever (L) corresponding to the engagement of a gear or the neutral position. From this position, possibly after having angularly moved lever (L) in one direction or another, to select a gear, lever (L) can either be pushed (this generally corresponds to going up one gear) (FIG. 3) or pulled (this generally corresponds going down one gear (FIG. 2).

When lever (L) is pulled in the direction of arrow (F) resulting in concomitant driving of member (5), cable strand (1) is subjected to a tensile force (F1) that causes movement of selection member (7).

In this case, strand (2) follows the angular displacement of shifting members (5) and (7) (arrow F2) (FIG. 2).

When lever (L) is pushed (arrow F3) resulting in concomitant driving of member (5), cable strand (2) is subjected to a tensile force (F4) that causes concomitant driving of selection member (8) Strand (1) follows the angular displacement of members (5) and (7).

The same kinematics is found in selection members (6) and (8) when lever (L) is moved angularly in one direction or another.

Given these arrangements, it follows therefore that the different cable strands (1), (2), (3) and (4) are subject, regardless of the direction of angular displacement of the lever (L), during both gear shifting and selection, to a tensile stress rather than thrust, as was the case according to the prior art, and that this makes it possible to use flexible cables having a very small diameter, of the bicycle cable type which are widely commercially available. This results in a significant saving.

Another advantage is the fact that the flexibility of the cables used, both for gear shifting and selection, makes it possible to have guide paths between control lever (L) and gearbox (BV) that are not necessarily straight.

Importantly, rotating members (5) and (6), on the lever side, define, relative to the axis of symmetry (X-X′) of lever (L), an angular sector a of about 20° on the even-gear shifting side and an angular sector 13 of about 40° on the odd-gear shifting side. The lever arm between, on the one hand, the axis of rotation of the rotating selection (6) and shifting (5) members on the lever side and (7) and (8) on the gearbox side and, on the other hand, the point of tangency of the cable strands (1), (2) and (3), (4) in relation to said members is always the same, so the ratio is constant. The connection between the lever and the selection return is in an oblong hole.

Advantageously, these arrangements enable a linear grid (FIG. 13), as opposed to known controls according to the prior art where the grid is “distorted”.

1. Device for controlling a mechanical gearbox by cables by using a lever comprising, in a vicinity of the lever and of the gearbox, members rotated as a result of displacement of the lever in order to exert a pull on coupling strands of flexible cables attached to said members, regardless of direction of angular displacement of the lever corresponding to gear shifting or gear selection, in a vicinity of the lever, one of the members being directly secured to said lever to constitute a gear shifting member, while an other member is controlled by the lever via a return element and constitutes a selection member.

2. The device as claimed in claim 1, wherein the members are at least partially circular.

3. The device as claimed in claim 1, wherein, in the level vicinity of the lever, the gear shifting member and the selection members are arranged in two vertical planes that are substantially parallel.

4. The device as claimed in claim 1, wherein, in a vicinity of the gearbox, a gear shifting member is arranged in a plane that is substantially horizontal while a selection member is arranged in a plane that is substantially vertical.

5. The device as claimed in claim 4, wherein the coupling strands between shifting members in the vicinity of the lever and of the gearbox and the coupling strands between selection members in the vicinity of the lever and of the gearbox are, respectively, part of a same cable that forms loops in the vicinity of said members.

6. The device as claimed in claim 4, wherein the coupling strands between shifting members in the vicinity of the lever and of the gearbox and the coupling strands between selection members in the vicinity of the lever and of the gearbox are, respectively, independent.

7. The device as claimed in claim 5, wherein the cables are fixed in features in an area of the rotating gear shifting members and in features in an area of the rotating selection members.

8. The device as claimed in claim 6, wherein the cables are fixed in features in two distinct areas of the rotating gear shifting members and in features in two distinct areas of the rotating selection members.

9. The device as claimed in claim 7, wherein the features for fixing the cables in the rotating shifting member and the rotating selection member in the vicinity of the lever, comprise an assembly including a tension shoe in which a locking pin is mounted, said assembly being subjected to a return spring and said locking pin being shaped to leave the cable free at time of assembly and then ensure locking of the shoe after the cable has been tensioned and secured.

10. The device as claimed in claim 9, wherein the cables are engaged in a peripheral groove in the rotating members in the vicinity of the lever, with the locking pin interacting with a protruding area formed on a periphery of the rotating shifting member and the selection member in the vicinity of the lever.

11. The device as claimed in claim 1, wherein, in the vicinity of the lever, the rotating members define, relative to an axis of symmetry of said lever, an angular sector of about 20° on an even-gear shifting side and of about 40° on an odd-gear shifting side, with said angular sectors being the same in the vicinity of the gearbox, connection between the lever and a selection return being obtained in an oblong hole.

12. The device as claimed in claim 11, wherein a lever arm between, on one hand, an axis of rotation of the selection and shifting members in the vicinity of the lever and of the gearbox and, on an other hand, a point of tangency of the coupling strands in relation to said members is always the same, so the ratio is constant.
